(19) United States
(12) Patent Application Publication
(10) Pub. No.: US 2013/0038049 A1
(43) Pub. Date: Feb. 14, 2013

(54) PRINT PUBLICATION, OF THE NEWSPAPER, DAILY, MAGAZINE OR PERIODICAL TYPE, CONTAINING EXTRACTABLE INSERTS

(71) Applicants: Aris BALLESTRAZZI, SAVIGNANO SUL PANARO (MO) (IT); Lamberto Tassi, Savignano Sul Panaro (MO) (IT)

(72) Inventors: Aris BALLESTRAZZI, SAVIGNANO SUL PANARO (MO) (IT); Lamberto Tassi, Savignano Sul Panaro (MO) (IT)

(73) Assignee: Sitma Machinery S.p.A., Spilamberto (IT)

(21) Appl. No.: 13/572,282

(22) Filed: Aug. 10, 2012

(30) Foreign Application Priority Data
Aug. 10, 2011 (IT) MI2011U 000275

(51) Int. Cl. B42D 1/00

(52) U.S. Cl. 281/15.1

(57) ABSTRACT

The present invention refers to a print publication (10), of the newspaper, daily, magazine or periodical type, comprising a sheet bundle (11) of printed sheets (12), wherein the sheet bundle has a front face (13), a rear face (14), at least one closed side (15) and at least one open side (16), and at least one extractable insert (17) which is arranged in an unfastened manner inside the sheet bundle (11) and that can be extracted from it through the at least one open side (16) thereof, and is characterised in that it comprises closing means of the removable type (18) of at least one tract of the open side (16) and suitable for preventing the insert (17) from accidentally slipping out.

The present invention refers to print publication, of the newspaper or daily or magazine or periodical type, containing extractable inserts.

For a long time it has been common to attach one or more extractable inserts to newspapers or dailies, magazines, periodicals or print publications in general.

In general, the inserts themselves are made of print publications dedicated to a specific field of information, for example finance, science, entertainment or similar, or giving extra information on a particular topic or even containing advertising information.

With particular, but not exclusive reference to newspapers, dailies, periodicals or magazines in general, the inserts thereto attached are inserted in an unfastened and free manner amongst their pages or between the two halves in which they are folded on themselves.

The insertion already occurs while packing the newspapers, dailies, periodicals or magazines or at a later moment, for example, by the sellers before they are displayed or distributed.

It is possible that, while handling such editorial products, during the storing, delivery, distribution and display steps, the inserts, precisely because they are arranged inside them in a free and unfastened manner, slip out.

In order to avoid such a drawback it is already known to pack such editorial products—each made of a newspaper, daily, periodical or magazine and of the relative inserts thereto attached—singularly in a respective bag made of plastic film or paper.

Such a packing necessarily requires a line dedicated and sized depending on the processed product.

Such a packing, moreover, requires the use of considerable amounts of plastic film for completely wrapping each product.

The purpose of the present invention is that of avoiding the drawbacks of the prior art.

In the field of such a general purpose, one purpose of the present invention is to make a print publication which permits to prevent the inserts, arranged in an unfastened and free manner inside it, from slipping out and coming out, in a simple and reliable manner.

Yet another purpose of the present invention is to make a print publication which, for its peculiar structural characteristics, is capable of giving the greatest guarantee of reliability and safety in use even with a limited use of materials.

A further purpose of the present invention is that of making a print publication which, besides ensuring that the inserts arranged in it in an unfastened and free manner be retained in its inside, is easy to obtain from elements and materials that can be commonly found on the market and that is, moreover, competitive in terms of price.

These and other purposes according to the present invention are achieved by making a print publication, of the newspaper or daily, magazine or periodical type, as outlined in claim 1.

Further characteristics of a print publication, of the newspaper or daily, magazine or periodical type, according to the present invention are object of the dependent claims.

The characteristics and the advantages of a print publication, of the newspaper or daily, magazine or periodical type, according to the present invention shall become clearer from the following description, given as an example and not for limiting purposes, with reference to the attached schematic drawings, in which:

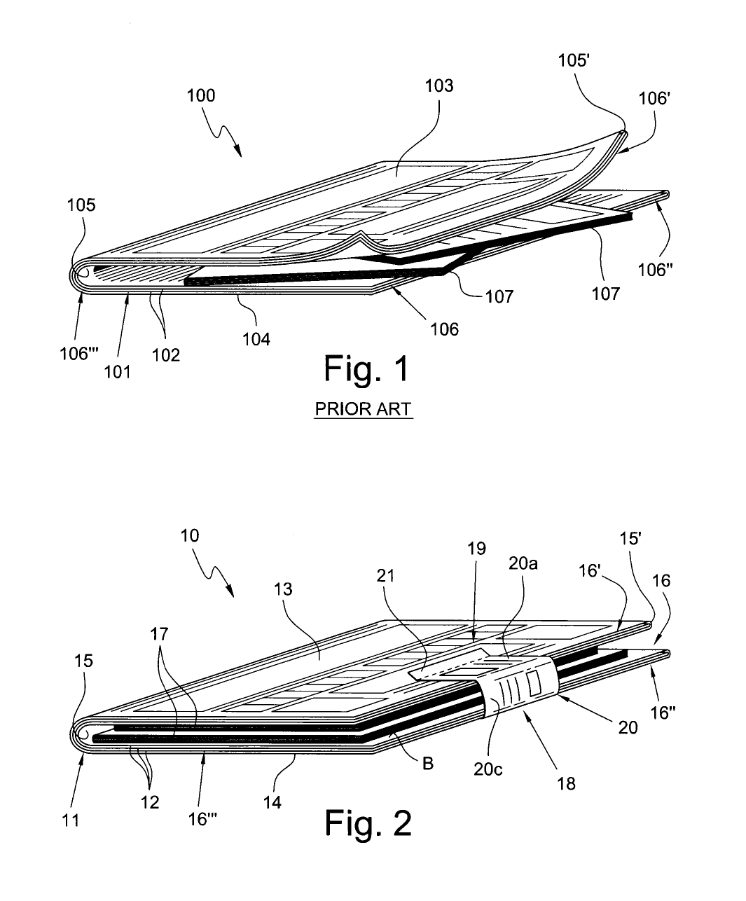

FIG. 1 is a perspective view of a print publication of the daily type folded on itself with a plurality of inserts arranged in an unfastened manner between the two overlapping halves thereof according to the prior art;

FIG. 2 is a perspective view of a print publication of the daily type folded on itself with a plurality of inserts arranged in an unfastened manner between its two overlapping halves according to the present invention;

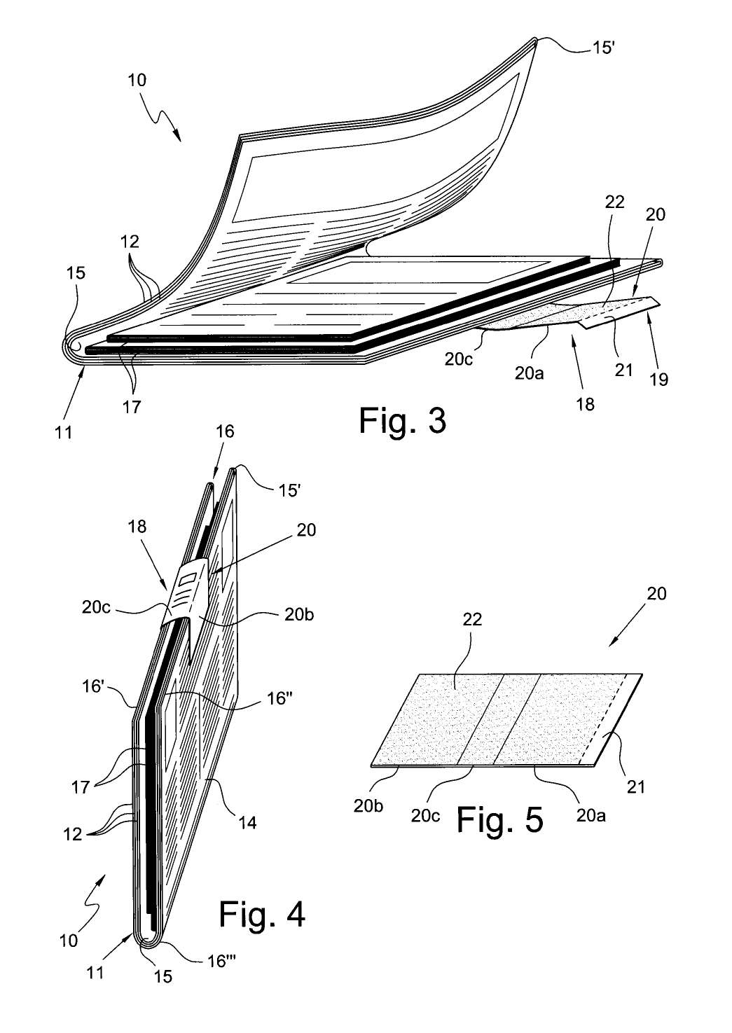

FIG. 3 is a perspective view showing the opening step of the print publication of FIG. 2;

FIG. 4 is a perspective view of the publication of FIG. 3 seen from the rear;

FIG. 5 is a perspective view of the closing means, of the removable type, of the print publication of FIGS. 2 to 4.

With reference to FIG. 1, a print publication 100 is shown, of the newspaper, daily, magazine, periodical type or similar according to the prior art.

The publication 100 comprises a sheet bundle 101 of sheets 102 having an upper face 103 and a rear face 104 and having at least one closed side 105 and at least one open side 106.

In particular, the publication 100 is of the newspaper or daily type in which each of the sheets 102 is folded on itself and the sheets 102 are inserted in each other, so that the set of sheets 102 folded and inserted in each other has a first closed side 105′ and three open sides 106′, 106″ and 106″′.

Such a set, as it is known, is further folded in half on itself, wherein the folding defines the closed side 105 from which two overlapping halves extend and the overlapping edges of which, in particular made of the open sides 106′ and 106″, define one or two open sides 106.

The surfaces of the two halves facing outwards define, on the other hand, the front face 103 and the rear face 104.

Between the two halves a plurality of inserts 107 is inserted, said inserts 107 being unfastened and free with respect to the sheet bundle 101.

Moreover, as it is known, the two halves have different width so that, by overlapping, one of the two, the larger one, has an edge that projects with respect to the other, defined in the jargon of the field as “overhang” and that, while packing the publication 100, it acts as a gripping element for the insertion between the two halves of the inserts 107.

As visible from FIG. 1, since the inserts 107 are not fastened to the sheet bundle 101, they can slip out of it through the one or more open sides 106.

FIGS. 2 to 4, show, on the other hand, a print publication 10, of the newspaper, daily, magazine or periodical type according to the present invention.

In an analogous manner to the known publications, the publication 10 comprises a sheet bundle 11 of sheets 12 that has an upper face 13 and a rear face 14 and that has at least one closed side 15 and at least one open side 16.

In particular, the publication 10 is of the newspaper or daily type in which each of the sheets 12 is folded on itself and the sheets 12 are inserted one in each other, so that the set of sheets 12, which are folded and inserted in one another, has a first closed side 15′ and three open sides 16′, 16″ and 16″′. Such a set, as it is known, is further folded in two on itself, wherein the folding defines the closed side 15 from which two overlapping halves extend and the overlapping edges of which, corresponding to the open sides 16′ and 16″, define one or two open sides 16.

The surfaces of the two halves facing outwards define, on the other hand, the front face 13 and the rear face 14.

Also in such a case, between the two halves a plurality of inserts 17 is inserted which are unfastened and free with respect to the sheet bundle 11.

As it is known, moreover, the two halves have different width so that, by overlapping, one of the two, the larger one, has an edge B that projects with respect to the other, which is defined in the jargon of the field as “overhang” and that, while packing the publication 10, it acts as a gripping element for the insertion of the inserts 17 between the two halves.

It is specified that the structure of the publication 10 could be different from that shown purely as an example and not for limiting purposes.

For example, the two halves could have equal width or be absent, the inserts 17 being directly inserted among the sheets 12 of the sheet bundle 11; the binding of the sheets 12, moreover, could be different, for example, they could be bound or stapled on the closed side 15.

A peculiar characteristic of the publication 10 according to the present invention consists in the fact that it comprises means 18, of the removable type, for closing at least one portion of the open side 16 and that are suitable for preventing the inserts 17 from accidentally slipping out of it.

Advantageously, the closing means 18 comprise a gripping element 19 that is suitable for facilitating its removal from the sheet bundle 11 for opening the corresponding side.

Moreover, advantageously, the closing means 18 have the surface, which is intended to face outwards and which can be printed on with personalization data, such as the address of the consignee, in case the publication 10 is sent by post, or advertising information or similar.

With reference to the embodiment represented in the attached FIGS. 2 to 5, the closing means 18 comprise a band 20 folded in two astride of one tract of the open side 16.

The band 20 has two end portions, a first end portion 20a and a second end portion 20b, respectively, of which the first end portion 20a is fastened to the front face 13 and the second end portion 20b is fastened to the rear face 14 of the publication 10.

The first end portion 20a and the second end portion 20b are joined by an intermediate portion 20c which is arranged astride of the tract of the open side 16.

In the embodiment represented in the attached figures, one or both the first end portion 20a and the second end portion 20b are fastened to the respective front face 13 and rear face 14 in a removable manner, for example through the interposition of an adhesive of the “peel and stick” type, so as to allow the reopening of the open side 16 and the extraction through it of the inserts 17.

Moreover, advantageously, at least one end edge of the first end portion 20a and/or of the second end portion 20b is made of a gripping element 19, of the type, for example, of a tab 21 without adhesive or at which the adhesive has been “deactivated” with methods known to a man skilled in the art, so as to facilitate the removal of the band 20.

However, alternative embodiments of the band 20 and, in particular, of the fastening modalities thereof at the front face 13 and at rear face 14 of the publication 10 and of its opening modalities are not excluded.

For example, the band 20 could have a portion for facilitating the breaking, which, for example, could be defined between the first end portion 20a and the second end portion 20b remaining astride of the open side 16. In such a case the removal of the band 20 for re-opening the tract of the open side 16 closed by it would occur through the breaking of the same.

FIG. 5 shows the development of a band 20 comprising the first end portion 20a, the intermediate portion 20c and the second end portion 20b which follow one another without solution of continuity and that have at the surface intended to be applied on the front face 13 and on the rear face 14 of the publication 10, respectively, an adhesive layer 22 of the “peel and stick” type.

At the end edge of the first end portion 20a the adhesive layer 22 is interrupted or “deactivated” so as to form the gripping tab 21.

The surface of the band 20 opposite the one covered with the adhesive layer 22 is, on the other hand, suitable for being printed on with known methods for displaying personalization data, information or advertisements.

Moreover, alternative embodiments of the closing means 18 are not ruled out, in general terms, they can comprise an element that is shaped or folded like a U, C or similar shape and is arranged astride of at least one portion of the open side 16 to contain a corresponding portion of the sheet bundle 11.

Such an element shaped or folded like a U, C or similar shape has two branches of which one can be fastened to the rear face 14 and the other one can be fastened to the front face 13 of the publication 10 and in which at least one of such two branches is fastened to the respective front face or rear face in a removable manner, for example through the interposition of one adhesive layer of the “peel and stick” type or in which, alternatively, a portion is present for facilitating the breaking for separating the two branches.

The print publication object of the present invention, thanks to the provision of closing means of the removable type applied to at least one tract of one or more of the open sides thereof, has the advantage of holding the inserts arranged in it in an unfastened manner, preventing them from slipping out and coming out through the open sides thereof, in a simple and effective manner.

The print publication object of the present invention, moreover, can be obtained through the use of materials and elements that can be easily found on the market and which have low cost.

It is finally clear that the print publication thus conceived can undergo numerous modifications and variants, all covered by the invention; moreover, all the details can be replaced by technically equivalent elements. In practice the materials used, as well as the dimensions, can be any according to the technical requirements.

1. A print publication, comprising:
a sheet bundle of printed sheets, wherein the sheet bundle has a front face, a rear face, at least one closed side and at least one open side,
at least one extractable insert which is arranged in an unfastened manner inside said sheet bundle and that can be extracted from said sheet bundle through said at least one open side; and
removable closing means for closing at least one tract of said at least one open side and suitable for preventing said at least one insert from accidentally slipping out.

2. A publication according to claim 1, wherein said closing means comprise a gripping element suitable for facilitating removal of the closing means from said sheet bundle so as to open the corresponding side.

3. A publication according to claim 1, wherein said closing means have a surface that is configured to face outwards that can be printed on with data.

4. A publication according to claim 3, wherein said closing means comprise an element shaped or folded as a U, C or similar shape which is arranged astride of said at least one tract of said at least one open side to contain a corresponding portion of said sheet bundle.

5. A publication according to claim 4, wherein said element shaped or folded as a U, C or similar shape has two branches of which one is fastened to said rear face and the other is fastened to said front face, wherein at least one of said two branches is fastened to the respective front or rear face in a removable manner.

6. A publication according to claim 4, wherein said element shaped or folded like a U, C or similar shape has two branches, of which one is fastened to said rear face and the other is fastened to said front face, and a portion for facilitating the breaking for separating said two branches.

7. A publication according to claim 6, wherein said closing means comprise a band folded in two astride of said at least one portion of said at least one open side and that has two end portions of which one is fastened to said rear face and the other is fastened to said front face, wherein at least one of said two end portions is fastened to the respective front face or rear face of said sheet bundle in a removable manner.

8. A publication according to claim 7, wherein said at least one of said two end portions that is fastened to the respective front face or rear face of said sheet bundle in a removable manner has a gripping element, which is suitable for facilitating the removal of said band and which can be gripped by a user.

9. A publication according to claim 7, wherein said at least one of said two end portions that is fastened to the respective front face or rear face of said sheet bundle in a removable manner is fastened to said sheet bundle through the interposition of an adhesive layer of the “peel and stick” type.

10. A publication according to claim 8, wherein said gripping element comprises a non adhesive tab defined at the end edge of said at least one of said two end portions.

11. A publication according to claim 10, wherein said closing means comprise a band folded in two astride of said at least one tract of said at least one open side and that has two end portions, of which one is fastened to said front face and the other is fastened to said rear face, and a portion for facilitating the breaking for separating said two end portions.

12. A publication according to claim 11, wherein each of the sheets of said sheet bundle is folded in two and wherein the sheets thus folded are inserted in each other, said at least one closed side being defined by the folding of said sheets and said insert being arranged among said folded sheets.

13. A publication according to claim 12, wherein the sheets of said sheet bundle are joined together, at one side and the plurality of said sheets joined together is further folded at least once on itself so as to define said at least one closed side from which two overlapping halves extend between which said insert is arranged and the surfaces facing outward of which define said front and rear faces.

14. A publication according to claim 13, wherein said halves have a different width.
